(19) United States
(12) Patent Application Publication
(10) Pub. No.: US 2009/0163693 A1
(43) Pub. Date: Jun. 25, 2009

(54) Photoactive aromatic polymers and preparation methods thereof

(75) Inventor: Eun Kyoung Kim, Seoul (KR)

Correspondence Address: D. PETER HOCHBERG CO. L.P.A., 1940 EAST 6TH STREET, CLEVELAND, OH, 44114, US

(73) Assignee: Industry-Academic Cooperation Foundation, Yonsei University, Seoul (KR)

(21) Appl. No.: 12/083,713

(22) PCT Filed: Apr. 24, 2007
(86) PCT No.: PCT/KR2007/001989

§ 371 Date: Jul. 7, 2008

(30) Foreign Application Priority Data
Jul. 5, 2006 (KR) 10-2006-0062937

(51) Int. Cl. C08G 65/38; C08G 61/02; C08G 75/06

(52) U.S. Cl. 528/212; 528/396; 528/397; 528/380; 528/392

(57) ABSTRACT

A photoactive aromatic polymer having high fluorescence, including an aromatic compound as a backbone, through the polymerization of aromatic polycyclic monomers and a photoactive aromatic polymer having high conductivity and fluorescence even in a state in which the photoactive aromatic polymer is formed into a thin film.

### CROSS-REFERENCE TO RELATED APPLICATIONS

This application is a National Stage application of International Application No. PCT/KR2007/001989, filed on Apr. 24, 2007, which claims priority of Korean patent application serial number 10-2006-0062937, filed on Jul. 5, 2006, the contents of which are incorporated by reference herein in their entireties.

### TECHNICAL FIELD

The present invention relates to a photoactive aromatic polymer and a method of preparing the same. More particularly, the present invention relates to a method of preparing a photoactive aromatic polymer by mixing a monomer having an aromatic ring with an acid catalyst and/or a comonomer and a polymer, and then polymerizing the mixture, and to the use thereof.

### BACKGROUND ART

With the advancement of optical technologies, such as an optical signal processing technology, optical recording technology, display technology, and the like, the demand for organic conjugated materials, which are used as a core material for optical products and exhibit electroconductivity, photoconductivity, fluorescence and/or luminescence, is continuously increasing.

Such organic conjugated materials, which have a pi-conjugated structure, are aromatic hydrocarbon compounds or aromatic compounds containing hetero atoms, such as O, N, S, Se, Te and/or a halogen. That is, the organic conjugated materials are compounds having one or more aromatic rings or polymers thereof.

These compounds having one or more aromatic rings, that is aromatic compounds, typically include naphthalene, anthracene, pyrene, carbazole, thiophene, pentacene, carbon black, carbon nanotubes, and polymers thereof. These aromatic compounds are used for organic electroluminescent materials, photoreceptors, or fluorescent materials.

However, these aromatic compounds have a problem in that, since they have low solubility and a strong molecular cohesive force, the workability thereof is not good when they are applied to devices. Therefore, it is difficult to produce a thin film using a polymer resin, and when a polymer thin film is produced using these aromatic compounds, the aromatic compounds and the resin polymer do not sufficiently dissolve in each other. Therefore aggregation between flat aromatic molecules, with the result that the produced thin film has bad electrical characteristics, such as fluorescent properties, electroconductivity, and the like, and is opaque.

Further, there is a problem in that when the aromatic compounds are stored for a long time, they are eluted from a polymer medium and thus become phase-separated, and thus after optical products including the aromatic compounds have been used for a long time, the optical products degrade with respect to signal reliability and storage stability.

As technologies for overcoming the above problems, a method of preparing a polymer by polymerizing anthracene using boron trifluoride diethyl etherate (BFEE), in which the prepared polymer has improved fluorescence compared to anthracene, has been proposed [Shi et al. (2005) Journal of Electro. Society, V.575, P.287]. However, this method has problems in that the yield thereof is very low, about 25%, and in that it is difficult to produce a transparent film using the prepared polymer.

Further, a method of synthesizing poly(9,10-anthracene diylidene) by polymerizing anthrone with PPA (poly(phosphoric acid)) has been proposed [Ref. Schopov et al. (1978) Polymer, V.19, P.1449]. However, this technology has problems in that the synthesis of the anthrone, which is a monomer serving as a starting material, is not easy, and in that the workability thereof is not good because the synthesized polymer has low solubility and thus dissolves in a toxic solvent, such as NMP.

Further, a method of preparing poly(octamethylene-9,10-anthrylene) by polymerizing octamethylene-9,10-anthrylene has been proposed [Sinigersy et al. (2000) V.12, P.1058]. However, this technology has a problem in that the synthesis of the octamethylene-9,10-anthrylene, which is a monomer, is difficult.

Further, Korean Unexamined Patent Application Publication No. 1996-0014171 discloses a method of preparing conjugated arylene and heteroarylene vinylene polymers by reacting aromatic ring structured materials with an aqueous potassium alkyl xanthate solution. However, the method has a problem in that, since a xanthate group acts as a leaving group and is converted into a precursor polymer which dissolves in an organic solvent at the time of a polymerization reaction, the conversion of the precursor polymer into poly(p-phenylene vinylene) is performed in the presence of a forming gas at a temperature of 150˜250° C., and thus the conversion reaction must be performed at a high temperature.

Further, the above method has a problem in that the precursor polymer must be synthesized via several steps because a sulfinyl or sulfonyl group must be used as the leaving group of the precursor polymer.

Moreover, when aromatic polymers are prepared using the above method, there is a problem in that it is difficult to introduce substituents for imparting different functions to the prepared aromatic polymers.

Accordingly, polymers which can increase the polymerization reactivity of polycyclic aromatic compounds and can impart different functions, such as electroconductivity, fluorescence, and the like, and methods of preparing the same have been keenly required. In order to accomplish the object of the present invention, the inventors conducted research to discover that polycyclic aromatic polymers can be prepared by the steps of mixing a monomer having an aromatic ring with an acid catalyst, a comonomer, and/or a polymer, and then polymerizing the mixture.

### SUMMARY OF THE PRESENT INVENTION

Accordingly, the present invention has been made to overcome the above problems occurring in the prior art, and an object of the present invention is to provide a photoactive aromatic polymer, including an aromatic compound as a backbone, which can be applied on various substrates to form a thin film, that is prepared by mixing an aromatic polycyclic compound monomer with X—CH₂OCH₃ (where X is F, Cl, Br, or I) and an acid catalyst, and then polymerizing the structure in order to increase the reactivity of an aromatic polycyclic compound.

Another object of the present invention is to provide a method of preparing a photoactive aromatic polymer, which can increase fluorescence efficiency and can be formed into a thin film without requiring that fluorescent molecules of the photoactive aromatic polymer to be substituted.

### BRIEF DESCRIPTION OF THE DRAWINGS

FIG. 1 is a photograph showing the fluorescence characteristics of a solution of anthracene and chloroform and a solution of a polymer prepared in Example 1 and chloroform;

FIG. 2 is a photograph showing the fluorescent thin film manufactured in Example 24; and

FIG. 3 is a graph showing the fluorescent switching characteristics of a photochromic fluorescent thin film with respect to ultraviolet and visible rays.

### DETAILED DESCRIPTION OF THE PRESENT INVENTION

### Best Mode for Carrying Out the Invention

In order to accomplish the above objects, an aspect of the present invention provides a photoactive aromatic polymer, represented by Formula 1 below, including an aromatic compound as a backbone:

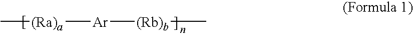

wherein n is an integer equal to or greater than 2; each of a and b is an integer from 0 to 20; Ar is an substituted or unsubstituted polycyclic aromatic ring; and each of Ra and Rb is an alkylene, alkyleneoxyalkylene, alkylenethioalkylene, or cyclic alkylene of 1 to 20 carbon atoms.

Another aspect of the present invention provides a method of preparing a photoactive aromatic polymer, including the steps of preparing a mixture by mixing 1 to 80% by weight of an aromatic polycyclic compound monomer, represented by Formula 2 below, 15 to 98.05% by weight of X—CH₂OCH₃ (where, X is F, Cl, Br, or I), and 0.05 to 70% by weight of an acid catalyst, based on total weight of the mixture; and polymerizing the mixture at a temperature of −78˜150° C.:

Y—(Ra)ₐ—Ar—(Rb)_{b}-Z (Formula 2),

wherein each of a and b is an integer from 0 to 20, Ar is a substituted or unsubstituted polycyclic aromatic ring, each of Ra and Rb is an alkylene, alkyleneoxyalkylene, alkylenethioalkylene, or cyclic alkylene of 1 to 20 carbon atoms, and each of Y and Z is H, Cl, F, Br, or I.

A further aspect of the present invention provides a method of preparing a photoactive aromatic polymer further comprising a step of adding 1 to 99% by weight of a compound represented by Formula 3 below, based on the total weight of the mixture, to the mixture for preparing a photoactive aromatic polymer:

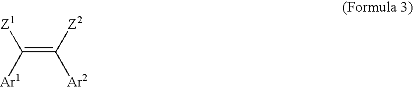

wherein each of Z¹ and Z² is a cyano group, maleic anhydride, maleimide dihydrothiophene, thiophene, or a ring of 4 to 6 atoms, unsubstituted or substituted with fluorine by the combination of Z¹ and Z² with each other; each of Ar¹ and Ar² is represented by

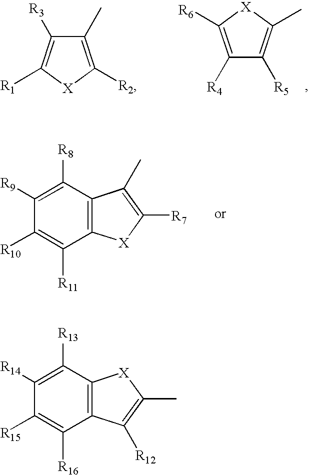

(where, each of X and Y is O, S, NH, N—CH₃, sulfone(SO₂) or sulfoxide(SO)); each of R₂, R₅, R₇ and R₁₂ is a substituted or unsubstituted alkyl group of C₁ to C₇, a substituted or unsubstituted alkyloxy group, a substituted or unsubstituted benzene ring, a substituted or unsubstituted thiophene, or a substituted or unsubstituted vinyl group; each of R₃ and R₆ is a hydrogen atom, a fluorine atom, or a substituted or unsubstituted alkyl group of C₁ to C₃, each of R₁, R₄, R₈ to R₁₁, and R₁₃ to R₁₆ is H, a halogen atom, a substituted or unsubstituted alkyl group of C₁ to C₇, a substituted or unsubstituted alkyloxy group, substituted or unsubstituted thiophene, a substituted or unsubstituted vinyl group, a substituted or unsubstituted triple bond, a substituted or unsubstituted benzene ring, —C(═O)CH₃, an isoxazol group, —C(═O)—CH₂—Ar³, —C(═O)—Ar⁴, or —N(Ar⁵)₂; and each of Ar³, Ar⁴ and Ar⁵ is a substituted or unsubstituted benzene ring or thiophene.

In this case, at least one of R₁, R₃, R₄, R₆, R₈ to R₁₁, and R₁₃ to R₁₆ is hydrogen and/or alkyl halide. Meanwhile, the photoactive aromatic polymer according to the present invention is a photoelectric polymer including an aromatic compound, preferably an aromatic polycyclic compound, as a backbone, such as a photoelectric conductive polymer, an ionic conductive polymer, a photoconductive polymer, or the like, and can be effectively applied to optical coating, imaging, optical disks, optical heads, holography media, optical recording, electrodes, optical switches, display devices, and/or sensors because they have excellent conductivity and fluorescence efficiency.

This photoactive aromatic polymer, represented by Formula 1 above, is prepared by polymerizing an aromatic polycyclic compound monomer, represented by Formula 2 above, with itself or polymerizing it with a comonomer represented by Formula 3 above and a polymer in the presence of an acid catalyst. Here, specifically, the aromatic polycyclic compound monomer represented by Formula 2 above is represented by Structural Formulas 1 to 29 below.

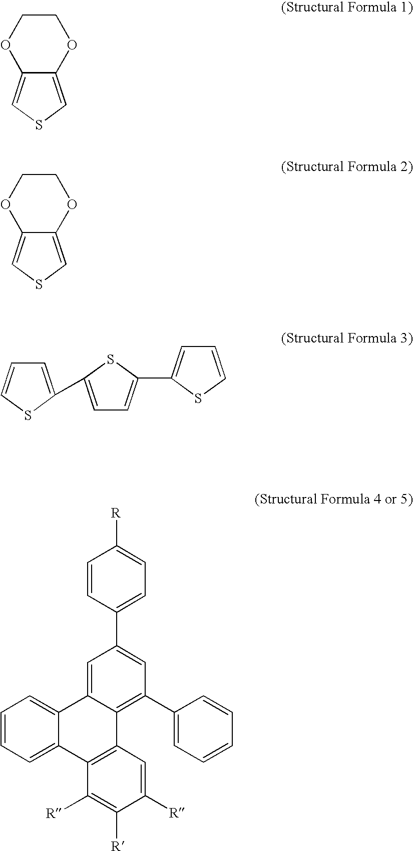

wherein the Structural Formula refers to Structural Formula 4a in the case of R═CH₃, R′═OCH₃, and R″═H; refers to Structural Formula 4b in the case of R═CH₃, and R′═R″═H; refers to Structural Formula 4c in the case of R═OCH₃, R′═OCH₃, and R″═H; refers to Structural Formula 5a in the case of R═CH₃, R′═NO₂, and R″═H; and refers to Structural Formula 5b in the case of R═CH₃ and R′═R″═OCH₃

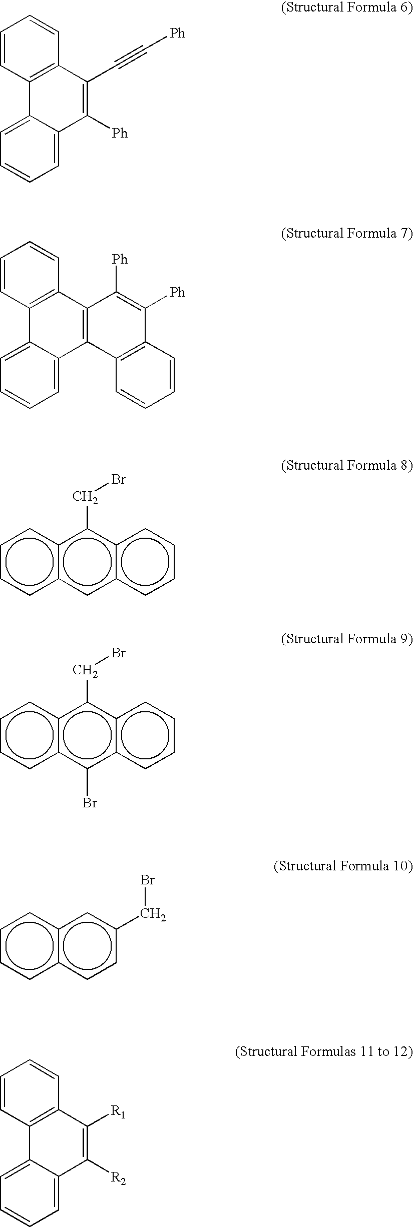

wherein the Structural Formula refers to Structural Formula 11a in the case of R₁═R₂═H, refers to Structural Formula 11b in the case of R₁═H and R₂═CH₃, and refers to Structural Formula 12 in the case of R₁═H and R₂═CH₂Cl

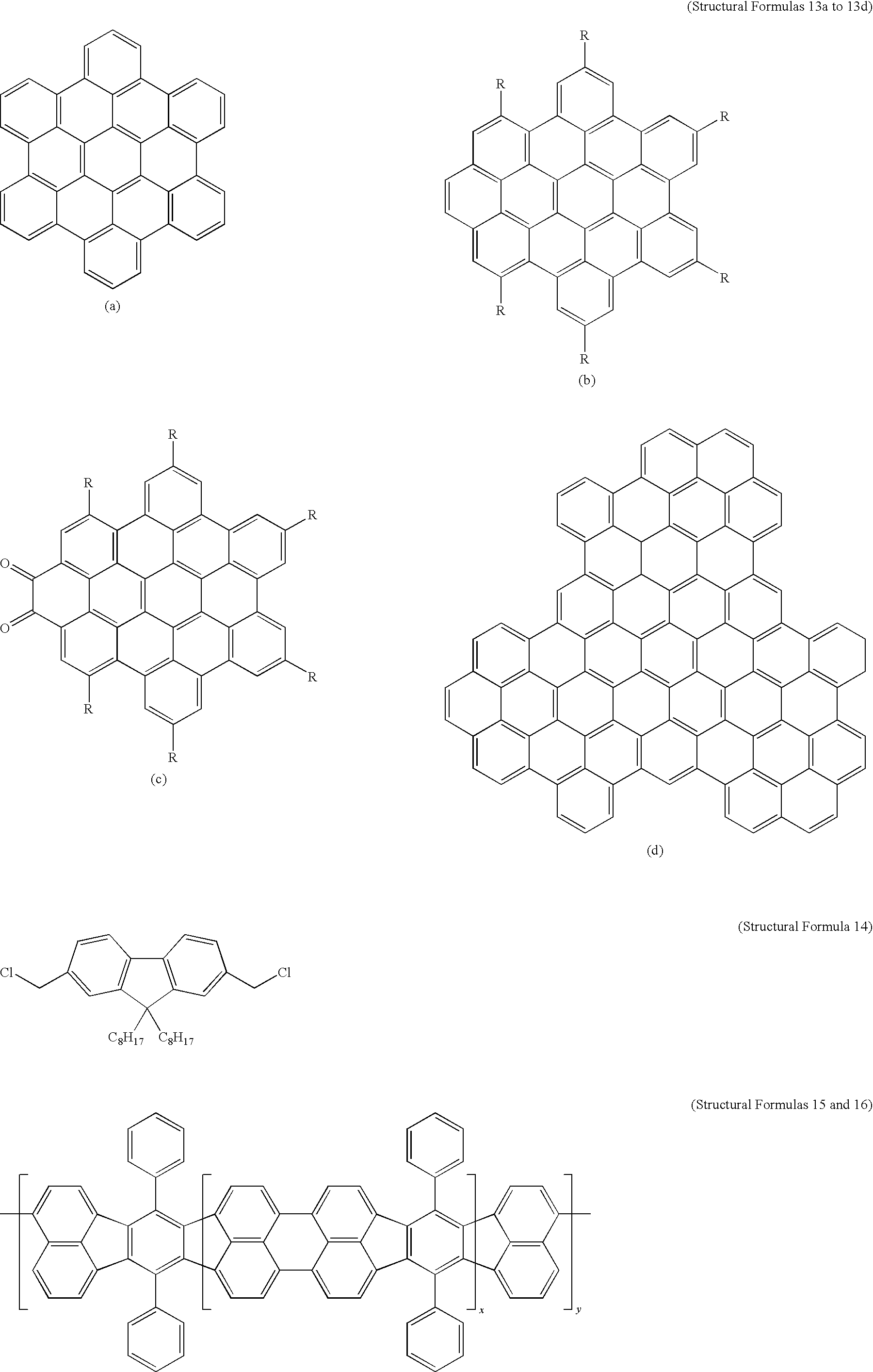

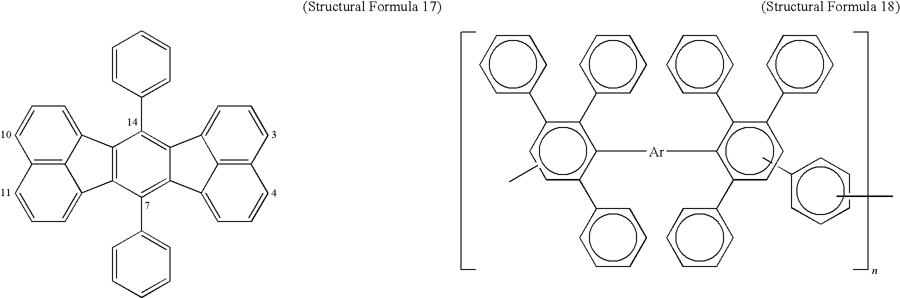

wherein, in the Structural Formula 18, Ar is

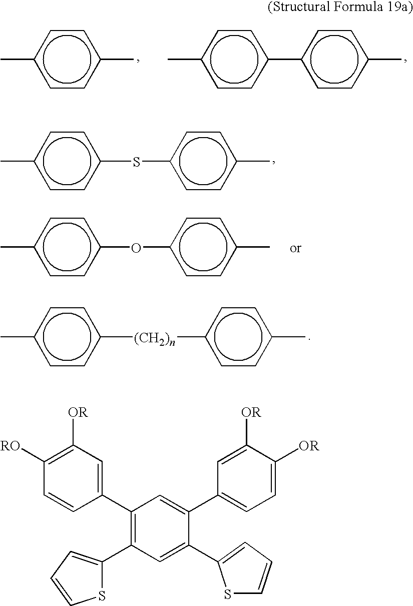

wherein, in the Structural Formula 19a, R is 2-ethylhexyl.

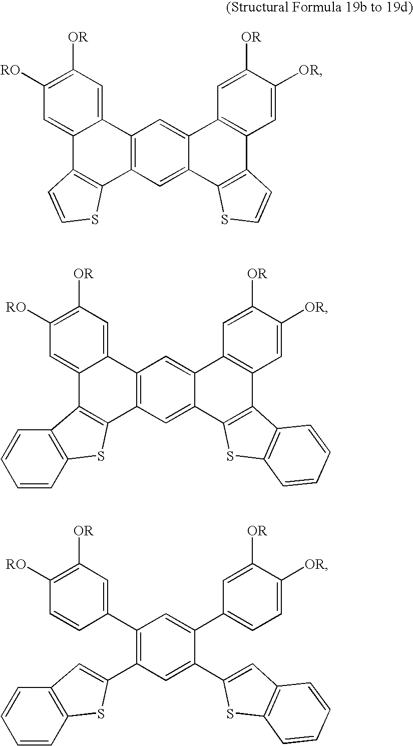

wherein, in the Structural Formulas 19b to 19d, R is an alkyl group of 1 to 20 carbon atoms.

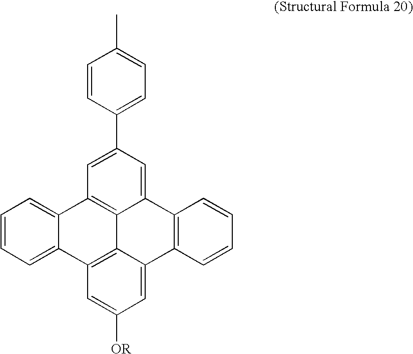

wherein, the Structural Formula refers to Structural Formula 20a in the case of R═H, and refers to Structural Formula 20b in the case of R═CH₃.

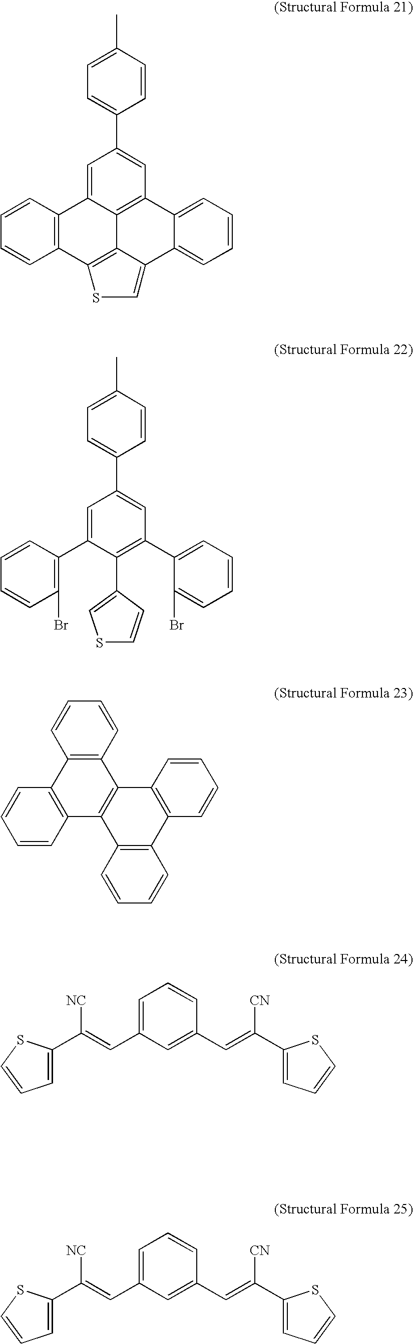

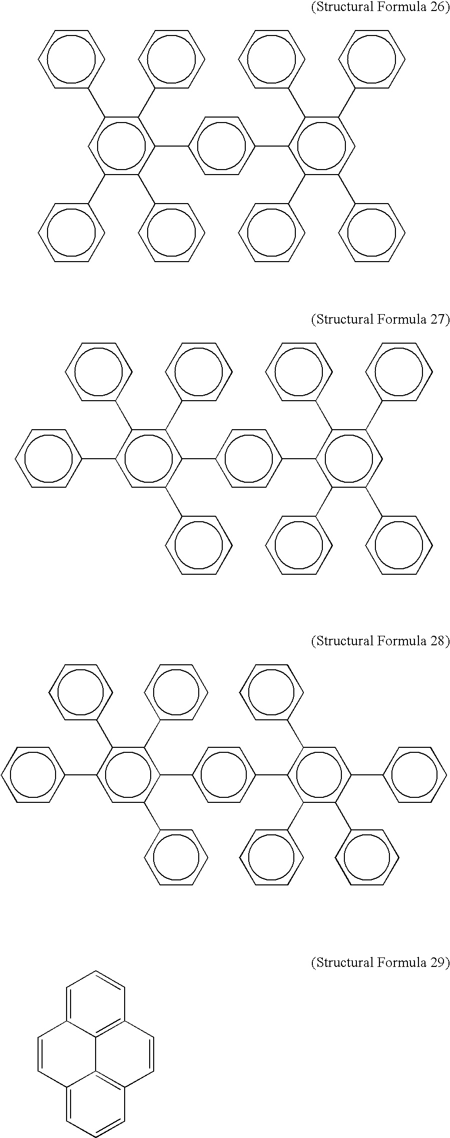

Meanwhile, the compound represented by Formula 3 is specifically represented by Structural Formulas 30 to 33.

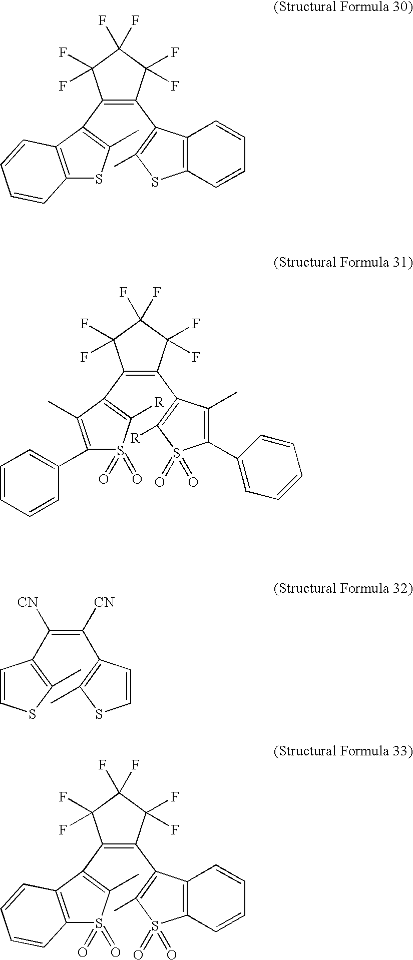

The photoactive aromatic polymer according to the present invention, represented by Formula 1 below, including an aromatic compound as a backbone, can be prepared using an aromatic polycyclic compound monomer represented by Formula 2, and a hydrocarbon compound substituted with a halogen group, represented by Formula 3, thiophene, and a mixture thereof, benzothiophene and a mixture thereof, dibenzothiophene and a mixture thereof, a substituted or unsubstituted benzene compound, an aromatic cyclic polymer, or a styrene polymer.

Here, in the case where a photoactive aromatic polymer is prepared using a compound represented by Formula 3, the block length, molecular weight and molecular weight distribution of the prepared photoactive aromatic polymer can be controlled. Therefore, a photoactive aromatic polymer having a desired performance can be prepared by controlling the length of the chains of the photoactive aromatic polymer prepared from the aromatic polycyclic compound monomer represented by Formula 2 in a desired form and controlling the molecular weight and molecular weight distribution thereof.

Meanwhile, in the case where the photoactive aromatic polymer, represented by Formula 1, according to the present invention is prepared, an acid catalyst is mixed with a mixture in order to perform a polymerization reaction. In this case, catalysts which can be used to perform a polymerization reaction are not particularly limited as long as they are acid catalysts commonly used in the related field, but preferably may be one or more mixtures selected from the group consisting of TiCl₄, SnCl₄, FeCl₃, AlCl₃, SbCl₅, POCl₃, TeCl₂, BiCl₃, ZnCl₂, ReCl₁₆, TiBr₄, BF₃.Et₂O, Sc(OTf)₃, TiF₄, CF₃SO₃H, H₂SO₄, and mixtures thereof. It is preferred that the amount of the catalyst used be in the range of 0.05 to 70% by weight, base on the total weight of the mixture for performing a polymerization reaction.

Further, in the preparation of the photoactive aromatic polymer, represented by Formula 1, according to the present invention, additives such as photosensitizers, agents for controlling molecular weight distribution, and the like, other than a comonomer represented by Formula 3 above and a polymer, may be added to the mixture for performing a polymerization reaction. In this case, the additive, such as a photosensitizer, an agent for controlling molecular weight distribution, or the like, may be added to the mixture in an amount of 0.001 to 50% by weight, and preferably 0.01 to 30% by weight, based on the total amount of the mixture.

Meanwhile, the polymerization reaction for preparing the photoactive aromatic polymer, represented by Formula 1, according to the present invention may be performed for 5 minutes ˜5 days, and preferably 1˜10 hours. The reaction temperature thereof may be in the range of −78 to 150° C., preferably −50 to 100° C., and more preferably −25 to 60° C. Solvents used for the polymerization reaction are not limited as long as they are solvents commonly used in the related field, but are preferably selected from among CH₂Cl₂, ClCH₂CH₂Cl, CHCl₃, THF, 1,4-dioxane, ether, water, and a mixture thereof.

As an aspect of the present invention, in the preparation of the photoactive aromatic polymer, represented by Formula 1, according to the present invention, in the case where Ar of Formula 2 is anthracene (1 equivalent), the Ar is dissolved in CH₂Cl₂ to form a solution. Subsequently, 0.9 equivalents of TiCl₄ is added to the solution, the solution to which TiCl₄ is added is stirred at a temperature of 0° C. for 10 minutes, and then the stirred solution is further stirred at room temperature for 30 minutes. Thereafter, CH₂Cl₂ is extracted from the solution and then a solvent is removed therefrom, thereby preparing an anthracene polymer. In this case, the anthracene polymer is dissolved in chloroform to form a solution, methanol is added to the solution to precipitate polymer to afford a fluorescent anthracene polymer having a weight-average molecular weight of 2,200 Da and high solubility in an organic solvent.

As another aspect of the present invention, in the preparation of the photoactive aromatic polymer, represented by Formula 1, according to the present invention, in the case where Ar of Formula 2 is a copolymer, anthracene (1 equivalent) and 2,5-bis(bromomethyl)-1,4-bis(hexyloxy)benzene(2,5-bis(bromoethyl)-1,4-bis(hexyloxy)benzene) (1 equivalent) are dissolved in CH₂Cl₂ to form a solution. Subsequently, FeCl₃ (1 equivalent), which is a Lewis acid, is added to the solution, and then the solution to which FeCl₃ is added is stirred at room temperature for 2 hours. Thereafter, CH₂Cl₂ is extracted from the solution and then the solvent is removed therefrom, thereby preparing a copolymer. In this case, the prepared copolymer is dissolved in ethyl acetate to form a solution, methanol is added to the solution, and then the solution, to which methanol is added, is precipitated and refined, thereby preparing a copolymer having high fluorescence and mechanical properties.

Here, in the preparation of the copolymer, a polymer having excellent optical characteristics can be prepared so as to have various characteristics, such as photochromic characteristics, fluorescence characteristics, and a desired refractive index, by adjusting the structure of the copolymer.

The comonomer used to prepare this copolymer may be alkyl halide, thiophene and derivatives thereof, benzothiophene and derivatives thereof, dibenzothiophene and derivatives thereof, or a substituted or unsubstituted aromatic benzene compound, and more specifically, may be thiophene, 3,4-dimethylthiophene, 2,3-dimethylbenzothiophene, 2-hexyl-3-methylthiophene, 2,5-Bis(bromoethyl)-1,4-bis(hexyloxy)benzene, 9-chloromethylanthracene, 9-bromomethylanthracene, pyrene, or the like.

In a further aspect of the present invention, a polymer or copolymer, prepared by polymerizing one or more monomers selected from among the aromatic benzene monomers of the aromatic polycyclic compound monomers represented by Formula 2 above and/or one or more compounds selected from among compounds represented by Formula 3 above, is mixed with a solvent to form a mixture, the mixture is stirred, the stirred mixture is applied on a substrate, such as a glass substrate, a transparent plastic substrate, a silicon wafer, or the like, coated with glass, quartz, Al, AlCr, Au, ITO, or the like, and then the substrate coated with the mixture is dried, thereby manufacturing a transparent thin film.

In an example of this method of manufacturing a thin film, an anthracene polymer is dissolved in chloroform to form a solution, the solution is stirred at room temperature for about 1 hour, the stirred solution is applied on a quartz substrate using a spin coating apparatus, and then the quartz substrate, coated with the solution, is dried at a temperature of about 50° C. for about 12 hours under reduced pressure, thereby manufacturing a transparent polymer thin film having high adhesivity to a quartz substrate.

When the polymer thin film manufactured in this way is irradiated with ultraviolet radiation, the polymer thin film exhibits fluorescence characteristics and, particularly, exhibits higher fluorescence than that of a monomer (for eg. Anthracene). Therefore, the polymer thin film can be applied to optical devices, such as optical recording devices, optical recording media, switches, displays, and the like, because its fluorescence intensity can be varied.

Meanwhile, a photoactive aromatic polymer, represented by Formula 1, according to the present invention, can be formed into a thin film composition by mixing the polymer with other polymers and a solvent. Preferably, the thin film composition may include, based on the total weight of the thin film composition, 0.1 to 90% by weight of a photoactive aromatic polymer represented by Formula 1; 10 to 99.9% by weight of a polymer resin selected from among polyolefin, polycarbonate, polymethylmethacrylate, polyester, polyvinyl alcohol, polyimide, epoxy, polyurethane, a styrene-diene polymer, or a mixture thereof; and 0 to 90% by weight of an organic solvent.

In this case, the thin film composition may further include, based on the total weight of the thin film composition, 0.001 to 50% by weight of a thickener, an antioxidant, a UV stabilizer, or a mixture thereof, commonly used in the related field.

Further, the thin film composition according to the present invention may be formed into a thin film by coating on a substrate, such as a silicon wafer, a glass substrate, or the like, with the composition, and then drying the coating object, coated with the composition, at room temperature, or more preferably at a temperature of about 130° C. If necessary, a final compact also may be formed by charging the thin film composition in a mold for forming a compact and then drying the composition charged in the mold, preferably at a temperature of about 130° C. Here, the method of applying the thin film composition on a substrate is not limited as long as the method is commonly used in the related field, but preferably may be a commonly used solution coating method, such as a spin coating method, a bar coating, a flow coating method, a spray coating method, or the like.

In another example of this method of manufacturing a thin film, 1 g of an anthracene polymer, which is one of the photoactive aromatic polymers, and 9 g of polymethylmethacrylate are dissolved in 95 g of chloroform and tetrachloroethane to form a thin film composition, and the thin film composition is applied on a quartz substrate using a spin coating method and then dried, thereby manufacturing a transparent thin film having a thickness of 2 μm.

In this case, the thin film composition may further include, as a substitute for or in addition to polymethylmethacrylate, included in the composition, polyvinyl chloride resins, polyvinyl acetate resins, vinyl chloride-vinyl acetate copolymers, polystyrene resins, styrene copolymers, phenoxy resins, polyester resins, aromatic polyester resins, polyurethane resins, polycarbonate resins, polyacrylate resins, polymethacrylate resins, acrylic copolymers, maleic anhydride copolymers, polyvinyl alcohol resins, modified polyvinyl alcohol resins, hydroxyethyl cellulose resins, carboxymethyl cellulose resins, starches, and mixtures thereof. Further, the organic solvent may further include, as substitutes for or in addition to chloroform and tetrachloroethane, which are used as the organic solvent, methanol, ethanol, isopropanol, n-butanol, methylisocarbinol, acetone, 2-butanone, ethyl amyl ketone, diacetone alcohols, isophorone, cyclohexanone, N,N-dimethylformamide, N,N-dimethylacetoamide, diethyl ether, diisopropyl ether, tetrahydrofuran, 1,4-dioxane, 3,4-dihydro-2H-pyran, 2-methoxy ethanol, 2-ethoxy ethanol, 2-butoxy ethanol, ethylene glycol dimethyl ether, methyl acetate, ethyl acetate, isobutyl acetate, amyl acetate, ethyl lactate, ethylene carbonate, aromatic hydrocarbons such as benzene, toluene, xylene, hexane, heptane, iso-octane, cyclohexane and the like, methylene chloride, 1,2-dichloroethane, dichloropropane, chlorobenzene, dimethylsulfoxide, N-methyl-2-pyrrolidone, tetrachloroethane, N-octyl-2-pyrrolidone, and mixtures thereof. If necessary, the composition may further include antioxidants, thickeners, waxes, static charging agents, and the like.

As described above, since a photoactive aromatic polymer, represented by Formula 1, including an aromatic compound as a backbone, according to the present invention, has fluorescence characteristics, the photoactive aromatic polymer can be variously used for organic semiconductors, optical recording media, display devices, recording devices, lenses, fibers, medical supplies, and the like.

Hereinafter, the present invention will be described in detail with reference to the examples. However, these examples are set forth to illustrate the present invention, and should not be construed as the limit of the present invention.

First, before the examples of the present invention are described, the properties of the materials prepared in the examples of the present invention, such as the molecular weight, fluorescence characteristics, conductivity, etc. thereof, are measured using the following test methods.

Further, reagents used in the following examples, were manufactured by SIGMA-ALDIRICH COMPANY [United States], TOKYO CHEMICAL INDUSTRY (TCI) CO., LTD. [Japan] or MERCK & CO., INC. [Germany], or synthesized using commonly known synthesis methods. As solvents used for reactions, solvents manufactured by SIGMA-ALDIRICH COMPANY (United States) or DUKSAN PURE CHEMICALS CO., LTD (Korea) were used.

<Test Method>

(1) Molecular weight: Weight averaged Molecular weight is measured by dissolving a polymer in dimethylformaldehyde (DMF) or tetrahydrofuran (THF) and then using GPC [Waters Alliance System, United States].

(2) Fluorescence characteristics: Fluorescence characteristics are measured by dissolving a polymer in a chloroform solution to have a concentration of 10⁻⁷ M and then using a luminescence spectrometer [luminescence spectrometer-Model LS55, PerkinElmer, United States].

(3) Conductivity: Conductivity is measured by forming a polymer film and then using an I-V measuring method [Potentiostat-Model CHI624B, CH Instrument Inc., United States].

### Example 1

Anthracene [0.5 g, SIGMA-ALDIRICH COMPANY, United States] was dissolved in 10 ml of CH₂Cl₂ [DUKSAN PURE CHEMICALS CO., LTD, Korea] to form a solution, the solution was cooled to a temperature of 0° C., the cooled solution was mixed with 1.8 mL of TiCl₄ (1M solution in toluene) [SIGMA-ALDIRICH COMPANY, United States] to form a mixture, and then the mixture was stirred for 30 minutes.

Subsequently, the stirred mixture was mixed with 0.15 ml of chloromethylmethyl ether [SIGMA-ALDIRICH COMPANY, United States], and was then reacted at room temperature for 30 minutes.

Subsequently, water was added to the reaction mixture to form a reaction product, and thus the reaction was completed. Then, an organic layer was extracted from the reaction product using ethyl acetate [SIGMA-ALDIRICH COMPANY, United States], and water included in the organic layer was removed using MgSO₄.

Subsequently, the solvent was removed by evaporation under reduced pressure, the solvent-free product was dissolved in a small amount of ethyl acetate, the dissolved product was precipitated by adding methanol thereto, and then the precipitated product was filtered, thereby preparing 0.25 g of a yellow polymer.

The weight-average molecular weight of the resultant prepared polymer was 2,178 Da (M_{w}/Mₙ=1.59).

Further, the structure of the product was determined using FTIR and NMR, and the results thereof are as follows.

FTIR: 780 cm⁻¹ (C—O—C, stretch), 1450 to 1350, 1680 cm⁻¹ (anthracene unit), 2995-2850 cm⁻¹ (aliphatic CH₂ stretch) and 3051 cm⁻¹ (aromatic C—H stretch)

¹H-NMR (CDCl₃, ppm): CH₂ (s, attached to aromatic carbon, 3.6 ppm), CH₂ (s, 2H, 5.6 ppm), 7.44-8.52 ppm (m, 8H, aromatic protons of anthracene).

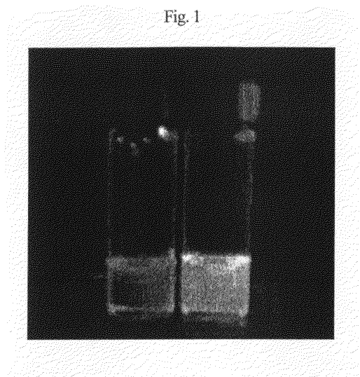

Meanwhile, the polymer prepared from the product exhibited a fluorescence quantum yield of 55% (maximum fluorescence wavelength: 430 nm) when the polymer was dissolved in a chloroform solution. In contrast, anthracene exhibits a fluorescence quantum yield of 31%. Therefore, the fluorescence characteristics of the polymer were found to be higher than those of anthracene. FIG. 1 shows the fluorescence characteristics of a polymer solution and an anthracene solution.

### Example 2

Example 2 was conducted in the same manner as Example 1, except that 1.8 g of anthracene was used in place of 0.5 g of anthracene, 1.4 g of FeCl₃[SIGMA-ALDIRICH COMPANY, United States] was used in place of 1.8 ml of TiCl₄, 20 ml of CH₂Cl₂ was used in place of 10 ml of CH₂Cl₂, 0.85 ml of chloromethylmethyl ether was used in place of 0.15 ml of chloromethylmethyl ether, and then the reaction was performed at a temperature of −10° C. instead of room temperature.

The weight-average molecular weight of the resultant prepared polymer was 2,213 Da (M_{w}/Mₙ=1.68), and the yield thereof was 80%.

### Example 3

Example 3 was conducted in the same manner as Example 1, except that 1.8 g of anthracene and 1.4 g of the compound represented by Structural Formula 1 [SIGMA-ALDIRICH COMPANY, United States] were used in place of 0.5 g of anthracene, 1.4 g of FeCl₃ was used in place of 1.8 ml of TiCl₄, 50 ml of CH₂Cl₂ was used in place of 10 ml of CH₂Cl₂, 1.2 ml of bromomethylmethyl ether [SIGMA-ALDIRICH COMPANY, United States] was used in place of 0.15 ml of chloromethylmethyl ether, and the reaction was performed at a temperature of −20° C. instead of room temperature.

The weight-average molecular weight of the resultant prepared polymer was 15,300 Da (M_{w}/Mₙ=1.51), and the yield thereof was 75%.

### Example 4

Example 4 was conducted in the same manner as Example 1, except that 1.7 g of the compound represented by Structural Formula 2 [SIGMA-ALDIRICH COMPANY, United States] and 2.48 g of the compound represented by Structural Formula 3 [SIGMA-ALDIRICH COMPANY, United States] were used in place of 0.5 g of anthracene, 1.6 g of TiCl₄ was used in place of 1.8 ml of TiCl₄, 20 ml of CH₂Cl₂ was used in place of 10 ml of CH₂Cl₂, 1.5 ml of chloromethylmethyl ether was used in place of 0.15 ml of chloromethylmethyl ether, and the reaction was performed at a temperature of −10° C. instead of room temperature.

The weight-average molecular weight of the resultant prepared polymer was 32,100 Da (M_{w}/Mₙ=1.59), and the yield thereof was 73%.

### Example 5

Example 5 was conducted in the same manner as Example 1, except that 3.5 g of the compound represented by Structural Formula 4a, prepared using the method disclosed in the document [Cheng, X. H.; Hoger, S.; Fenske, D. Org. Lett.; V.5(15); P. 2587-2589, 2003], was used in place of 0.5 g of anthracene, 1.6 g of TiCl₄ was used in place of 1.8 ml of TiCl₄, 20 ml of CH₂Cl₂ was used in place of 10 ml of CH₂Cl₂, 1.5 ml of chloromethylmethyl ether was used in place of 0.15 ml of chloromethylmethyl ether, and the reaction was performed at a temperature of −10° C. instead of room temperature.

The weight-average molecular weight of the resultant prepared polymer was 32,100 Da (M_{w}/Mₙ=1.59), and the yield thereof was 73%.

### Example 6

Example 6 was conducted in the same manner as Example 1, except that 2.5 g of the compound represented by Structural Formula 5a [SIGMA-ALDIRICH COMPANY, United States] and 2 g of the compound represented by Structural Formula 7, prepared using the method disclosed in the document [Tuanli Yao, Marino A. Campo, and Richard C. Larock J. Org. Chem., V.70(9), P.3511-3517, 2005], were used in place of 0.5 g of anthracene, 1.1 ml of TiCl₄ and 1.4 g of FeCl₃ were used in place of 1.8 ml of TiCl₄, 23 ml of CH₂Cl₂ and 10 ml of toluene were used in place of 10 ml of CH₂Cl₂, 1.8 ml of chloromethylmethyl ether was used in place of 0.15 ml of chloromethylmethyl ether, and the reaction was performed for 4 hours instead of 30 minutes.

The weight-average molecular weight of the resultant prepared polymer was 6,700 Da (M_{w}/Mₙ=2.19), and the yield thereof was 69%.

### Example 7

Example 7 was conducted in the same manner as Example 1, except that 2.5 g of the compound represented by Structural Formula 8 [SIGMA-ALDIRICH COMPANY, United States] was used in place of 0.5 g of anthracene, 1.6 g of TiBr₄ [SIGMA-ALDIRICH COMPANY, United States] was used in place of 1.8 ml of TiCl₄, 10 ml of toluene and 20 ml of xylene were used in place of 10 ml of CH₂Cl₂, 1.9 ml of bromomethylmethyl ether was used in place of 0.15 ml of chloromethylmethyl ether, and the reaction was performed for 4 hours instead of 30 minutes.

The weight-average molecular weight of the resultant prepared polymer was 7,800 Da (M_{w}/Mₙ=1.64), and the yield thereof was 82%.

### Example 8

Example 8 was conducted in the same manner as Example 1, except that 2.5 g of the compound represented by Structural Formula 10 [SIGMA-ALDIRICH COMPANY, United States] and 1 g of the compound represented by Structural Formula 11a, prepared using the method disclosed in the document [Tuanli Yao, Marino A. Campo, and Richard C. Larock J. Org. Chem., V.70(9), P.3511-3517, 2005], were used in place of 0.5 g of anthracene, 1.7 g of AlCl₃ [SIGMA-ALDIRICH COMPANY, United States] was used in place of 1.8 ml of TiCl₄, 20 ml of CH₂Cl₂ was used in place of 10 ml of CH₂Cl₂, 1.8 ml of chloromethylmethyl ether was used in place of 0.15 ml of chloromethylmethyl ether, and the reaction was performed for 4 hours instead of 30 minutes.

The weight-average molecular weight of the resultant prepared polymer was 3,700 Da (M_{w}/Mₙ=2.21), and the yield thereof was 62%.

### Example 9

Example 9 was conducted in the same manner as Example 1, except that 0.5 g of the compound represented by Structural Formula 13a, prepared using the method disclosed in the document [Wang, Z.; Tomovic, Z.; Kastler, M.; Pretsch, R.; Negri, F.; Enkelmann, V.; Mullen, K. J. Am. Chem. Soc.; (Communication); V.126(25); P. 7794-7795, 2004, DOI: 10.1021/ja048580d], and 0.2 g of the compound represented by Structural Formula 13d, prepared using the method disclosed in the document [Wang, Z.; Tomovic, Z.; Kastler, M.; Pretsch, R.; Negri, F.; Enkelmann, V.; Mullen, K. J. Am. Chem. Soc.; (Communication); V.126(25); P.7794-7795, 2004, DOI: 10.1021/ja048580d], were used in place of 0.5 g of anthracene, 0.6 g of TiCl₄ and 1.7 g of FeCl₃ were used in place of 1.8 ml of TiCl₄, 20 ml of CH₂Cl₂ was used in place of 10 ml of CH₂Cl₂, 0.5 ml of chloromethylmethyl ether was used in place of 0.15 ml of chloromethylmethyl ether, and the reaction was performed for 12 hours instead of 30 minutes.

The weight-average molecular weight of the resultant prepared polymer was 4,300 Da (M_{w}/Mₙ=2.91), and the yield thereof was 66%.

### Example 10

Example 10 was conducted in the same manner as Example 1, except that 0.8 g of anthracene and 2 g of the compound represented by Structural Formula 14, prepared using the method disclosed in the document [Jin, S.-H.; Park, H.-J.; Kim, J. Y.; Lee, K.; Lee, S.-P.; Moon, D.-K.; Lee, H.-J.; Gal, Y.-S. Macromolecules; (Communication to the Editor); V.35(20); P.7532-7534, 2002, DOI: 10.1021/ma020671c], were used in place of 0.5 g of anthracene, 1.6 g of AlCl₃ was used in place of 1.8 ml of TiCl₄, 20 ml of CH₂Cl₂ was used in place of 10 ml of CH₂Cl₂, 2.6 ml of chloromethylmethyl ether was used in place of 0.15 ml of chloromethylmethyl ether, and the reaction was performed for 5 hours instead of 30 minutes.

The resultant prepared polymer exhibited its maximum fluorescence peak at a wavelength of 520 nm, the weight-average molecular weight thereof was 2,700 Da (M_{w}/Mₙ=2.33), and the yield thereof was 45%.

### Example 11

Example 11 was conducted in the same manner as Example 1, except that 2.2 g of the compound represented by Structural Formula 17, prepared using the method disclosed in the document [Debad, J. D.; Bard, A. J. J. Am. Chem. Soc.; (Communication); V.120(10); P.2476-2477, 1998], was used in place of 0.5 g of anthracene, 0.6 g of SnCl₄ and 0.6 g of FeCl₃ were used in place of 1.8 ml of TiCl₄, 20 ml of CH₂Cl₂ was used in place of 10 ml of CH₂Cl₂, 1.8 ml of chloromethylmethyl ether was used in place of 0.15 ml of chloromethylmethyl ether, and the reaction was performed for 4 hours instead of 30 minutes.

The weight-average molecular weight of the resultant prepared polymer was 5,700 Da (M_{w}/Mₙ=2.19), and the yield thereof was 69%.

### Example 12

Example 12 was conducted in the same manner as Example 1, except that 1.5 g of the compound represented by Structural Formula 18a, prepared using the method disclosed in the document [Shifrina, Z. B.; Averina, M. S.; Rusanov, A. L.; Wagner, M.; Mullen, K. Macromolecules; V.33(10); P.3525-3529, 2000, DOI: 10.1021/ma991369f], and 1 g of the compound represented by Structural Formula 19a, prepared using the method disclosed in the document [Tovar, J. D.; Rose, A.; Swager, T. M. J. Am. Chem. Soc.; V.124(26); P.7762-7769, 2002, DOI: 10.1021/ja0262636], were used in place of 0.5 g of anthracene, 1.6 g FeCl₃ was used in place of 1.8 ml of TiCl₄, 20 ml of toluene and 20 ml of xylene were used in place of 10 ml of CH₂Cl₂, 1.9 ml of bromomethylmethyl ether was used in place of 0.15 ml of chloromethylmethyl ether, and the reaction is performed for 4 hours instead of 30 minutes.

The weight-average molecular weight of the resultant prepared polymer was 9,700 Da (M_{w}/Mₙ4=3.15), and the yield thereof was 55%.

### Example 13

Example 13 was conducted in the same manner as Example 1, except that 2.5 g of the compound represented by Structural Formula 20a, prepared using the method disclosed in the document [Cheng, X. H.; Jester, S.-S.; Hoger, S. Macromolecules; V.37(19); P.7065-7068, 2004, DOI: 10.1021/ma048728d], was used in place of 0.5 g of anthracene, 1.6 g FeCl₃ was used in place of 1.8 ml of TiCl₄, 20 ml of toluene and 20 ml of xylene were used in place of 10 ml of CH₂Cl₂, 1.9 ml of bromomethylmethyl ether was used in place of 0.15 ml of chloromethylmethyl ether, and the reaction was performed for 10 hours instead of 30 minutes.

The weight-average molecular weight of the resultant prepared polymer was 2,900 Da (M_{w}/Mₙ=1.72), and the yield thereof was 52%.

### Example 14

Example 14 was conducted in the same manner as Example 1, except that 2.5 g of the compound represented by Structural Formula 21, prepared using the method disclosed in the document [Cheng, X. H.; Jester, S.-S.; Hoger, S. Macromolecules; V.37(19); P.7065-7068, 2004, DOI: 10.1021/ma048728d], and 2 g of the compound represented by Structural Formula 22, prepared using the method disclosed in the document [Cheng, X. H.; Jester, S.-S.; Hoger, S. Macromolecules; V.37(19); P.7065-7068, 2004, DOI: 10.1021/ma048728d], were used in place of 0.5 g of anthracene, 1.6 g TiCl₄ was used in place of 1.8 ml of TiCl₄, 20 ml of CH₂Cl₂ was used in place of 10 ml of CH₂Cl₂, 1.8 ml of chloromethylmethyl ether was used in place of 0.15 ml of chloromethylmethyl ether, and the reaction was performed for 4 hours instead of 30 minutes.

The weight-average molecular weight of the resultant prepared polymer was 3,800 Da (M_{w}/Mₙ=2.67), and the yield thereof was 48%.

### Example 15

Example 15 was conducted in the same manner as Example 1, except that 2.1 g of the compound represented by Structural Formula 23, prepared using the method disclosed in the document [Yamaguchi, S.; Swager, T. M. J. Am. Chem. Soc.; (Communication); V.123(48); P.12087-12088, 2001, DOI: 10.1021/ja016692d], was used in place of 0.5 g of anthracene, 1.1 g FeCl₃ was used in place of 1.8 ml of TiCl₄, 20 ml of toluene and 20 ml of xylene were used in place of 10 ml of CH₂Cl₂, and 1.8 ml of bromomethylmethyl ether was used in place of 0.15 ml of chloromethylmethyl ether.

The weight-average molecular weight of the resultant prepared polymer was 4,200 Da (M_{w}/Mₙ=2.71), and the yield thereof was 55%.

### Example 16

Example 16 was conducted in the same manner as Example 1, except that 2.5 g of the compound represented by Structural Formula 24, prepared using the method disclosed in the document [Yamaguchi, S.; Swager, T. M. J. Am. Chem. Soc.; (Communication); V.123(48); P.12087-12088, 2001, DOI: 10.1021/ja016692d], and 2 g of the compound represented by Structural Formula 25, prepared using the method disclosed in the document [Lin, S.-C.; Chen, J.-A.; Liu, M.-H.; Su, Y. O.; Leung, M.-k. J. Org. Chem.; V.63(15); P.5059-5063, 1998, DOI: 10.1021/jo980239 m], were used in place of 0.5 g of anthracene, 0.6 g of SnCl₄ and 1.1 g of FeCl₃ were used in place of 1.8 ml of TiCl₄, 20 ml of toluene and 20 ml of xylene were used in place of 10 ml of CH₂Cl₂, and 1.8 ml of bromomethylmethyl ether was used in place of 0.15 ml of chloromethylmethyl ether.

The weight-average molecular weight of the resultant prepared polymer was 4,700 Da (M_{w}/Mₙ=2.68), and the yield thereof was 50%.

### Example 17

Example 17 was conducted in the same manner as Example 1, except that 2 g of the compound represented by Structural Formula 26, prepared using the method disclosed in the document [Shifrina, Z. B.; Averina, M. S.; Rusanov, A. L.; Wagner, M.; Mullen, K. Macromolecules; V.33(10); P.3525-3529, 2000, DOI: 10.1021/ma991369f], was used in place of 0.5 g of anthracene, 1.6 g of TiCl₄ and 2 g of ZnCl₂ were used in place of 1.8 ml of TiCl₄, 20 ml of CH₂Cl₂ was used in place of 10 ml of CH₂Cl₂, 1.8 ml of chloromethylmethyl ether was used in place of 0.15 ml of chloromethylmethyl ether, and the reaction was performed for 4 hours instead of 30 minutes.

The weight-average molecular weight of the resultant prepared polymer was 6,700 Da (M_{w}/Mₙ4=2.19), and the yield thereof was 69%.

### Example 18

Example 18 was conducted in the same manner as Example 1, except that 2.1 g of the compound represented by Structural Formula 27, prepared using the method disclosed in the document [Shifrina, Z. B.; Averina, M. S.; Rusanov, A. L.; Wagner, M.; Mullen, K. Macromolecules; V.33(10); P.3525-3529, 2000, DOI: 10.1021/ma991369f], and 0.2 g of the compound represented by Structural Formula 28, prepared using the method disclosed in the document [Shifrina, Z. B.; Averina, M. S.; Rusanov, A. L.; Wagner, M.; Mullen, K. Macromolecules; V.33(10); P.3525-3529, 2000, DOI: 10.1021/ma991369f], were used in place of 0.5 g of anthracene, 1.6 g of TiBr₄, prepared using the method disclosed in the document [CAN. J. CHEM. V.55, P.3882, 1977], was used in place of 1.8 ml of TiCl₄, 20 ml of CH₂Cl₂ was used in place of 10 ml of CH₂Cl₂, 1.8 ml of chloromethylmethyl ether was used in place of 0.15 ml of chloromethylmethyl ether, and the reaction is performed for 4 hours instead of 30 minutes.

The weight-average molecular weight of the resultant prepared polymer was 2,700 Da (M_{w}/Mₙ=2.11), and the yield thereof was 49%.

### Example 19

Example 19 was conducted in the same manner as Example 1, except that 2 g of anthracene and 1 g of 2-heptyl-3-methylbenzo[b]thiophene were used in place of 0.5 g of anthracene, 1.1 g of FeCl₃ was used in place of 1.8 ml of TiCl₄, 20 ml of CH₂Cl₂ was used in place of 10 ml of CH₂Cl₂, 1.8 ml of bromomethylmethyl ether was used in place of 0.15 ml of chloromethylmethyl ether, and the reaction was performed for 5 hours instead of 30 minutes.

The weight-average molecular weight of the resultant prepared polymer was 6,700 Da (M_{w}/Mₙ=2.19), and the yield thereof was 69%.

### Example 20

Example 20 was conducted in the same manner as Example 1, except that 0.5 g of the compound represented by Formula 9 [SIGMA-ALDIRICH COMPANY, United States] and 1.5 g of the compound represented by Structural Formula 30, prepared using the method disclosed in the document [Eunkyoung Kim*, Yun-Ki Choi, Myong Hyun Lee, Macromolecules, V.32, P.4855˜4860, 1999], were used in place of 0.5 g of anthracene, 1.1 g of FeCl₃ was used in place of 1.8 ml of TiCl₄, 20 ml of CH₂Cl₂ was used in place of 10 ml of CH₂Cl₂, 1.8 ml of bromomethylmethyl ether was used in place of 0.15 ml of chloromethylmethyl ether, and the reaction was performed for 5 hours instead of 30 minutes.

The weight-average molecular weight of the resultant prepared polymer was 16,600 Da (M_{w}/Mₙ=2.11), and the yield thereof was 86%.

### Example 21

Example 21 was conducted in the same manner as Example 1, except that 2.5 g of the compound represented by Formula 11b, prepared using the method disclosed in the document [Tuanli Yao, Marino A. Campo, and Richard C. Larock, J. Org. Chem., V.70(9) P.3511-3517, 2005], and 2 g of the compound represented by Structural Formula 30 were used in place of 0.5 g of anthracene, 1.1 g of FeCl₃ was used in place of 1.8 ml of TiCl₄, 20 ml of CH₂Cl₂ was used in place of 10 ml of CH₂Cl₂, 1.8 ml of chloromethylmethyl ether was used in place of 0.15 ml of chloromethylmethyl ether, and the reaction was performed for 4 hours instead of 30 minutes.

The weight-average molecular weight of the resultant prepared polymer was 36,100 Da (M_{w}/Mₙ=3.19), and the yield thereof was 81%.

### Example 22

Example 22 was conducted in the same manner as Example 1, except that 1 g of the compound represented by Formula 6, prepared using the method disclosed in the document [Tuanli Yao, Marino A. Campo, and Richard C. Larock, J. Org. Chem., V.70(9), P.3511-3517, 2005], and 2.5 g of the compound represented by Structural Formula 33, prepared using the method disclosed in the document [Yong-Chul Jeong, Sung Ik Yang*, Kwang-Hyun Ahn* and Eunkyoung Kim*, Chem. Comm., V.19, P.2503, 2005], were used in place of 0.5 g of anthracene, 1.6 g of TiCl₄ was used in place of 1.8 ml of TiCl₄, 20 ml of CH₂Cl₂ was used in place of 10 ml of CH₂Cl₂, 1.8 ml of chloromethylmethyl ether was used in place of 0.15 ml of chloromethylmethyl ether, and the reaction was performed for 4 hours instead of 30 minutes.

The weight-average molecular weight of the resultant prepared polymer was 9,540 Da (M_{w}/Mₙ=1.89), and the yield thereof was 73%.

### Example 23

Example 23 was conducted in the same manner as Example 1, except that 1.5 g of the compound represented by Formula 4a, prepared using the method disclosed in the document [Cheng, X. H.; Hoger, S.; Fenske, D. Org. Lett.; V.5(15); P.2587-2589, 2003], and 1.2 g of the compound represented by Structural Formula 33 were used in place of 0.5 g of anthracene, 2.1 g of FeCl₃ and 0.2 g of BF₃□Et₂O were used in place of 1.8 ml of TiCl₄, 20 ml of CH₂Cl₂ was used in place of 10 ml of CH₂Cl₂, 1.8 ml of bromomethylmethyl ether was used in place of 0.15 ml of chloromethylmethyl ether, and the reaction was performed for 5 hours instead of 30 minutes.

The weight-average molecular weight of the resultant prepared polymer was 16,900 Da (M_{w}/Mₙ=2.23), and the yield thereof was 81%.

### Example 24

Manufacture of Fluorescent Thin Film

1 g of the polymer prepared in Example 2 was dissolved in 19.5 g of chloroform to form a mixed solution, and then the mixed solution was stirred at room temperature for 1 hour.

Subsequently, the mixed solution was filtered, and was then applied on a quartz plate [HELMA CORP., Swiss] using a spin coating machine [ISP-2002F, INPEC CORP., Korea].

Subsequently, the quartz plate coated with the solution was dried in an oven at a temperature of 50° C. for 12 hours under reduced pressure, thereby manufacturing a fluorescent thin film.

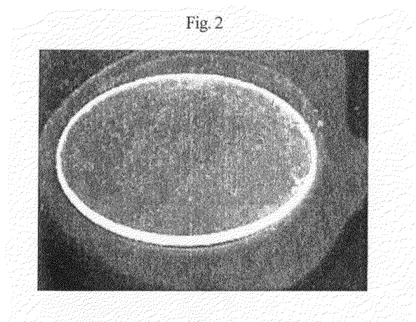

As a result, FIG. 2 shows the manufactured fluorescent thin film.

As shown in FIG. 2, the manufactured fluorescent thin film exhibits fluorescent characteristics, has high adhesivity, has a transmittance of 90% or more, has a thickness of 800 nm, and does not undergo phase separation when it is repeatedly irradiated.

Further, after the solution was applied on an ITO glass, the conductivity thereof was measured using an I-V graph. The conductivity of the resultant polymer thin film prepared therefrom was 0.001 S/cm.

### Example 25

Manufacture of Photochromic Fluorescent Thin Film

1 g of the polymer prepared in Example 22 was dissolved in 10 mL of a cosolvent of chloroform and tetrachloroethane to form a mixed solution, and then the mixed solution was applied on a quartz plate [HELMA CORP., Swiss] using a spin coating machine [ISP-2002F, INPEC CORP., Korea].

Subsequently, the quartz plate [HELMA CORP., Swiss] coated with the solution was dried in a vacuum oven [JEIO TECH CORP., Korea] at a temperature of 80° C. for 6 hours, thereby manufacturing a transparent thin film having a thickness of 2 μm.

As a result, when the manufactured thin film was irradiated with 8 mW of ultraviolet, it fluoresced strongly and simultaneously turned yellow within 5 seconds; when it was left in a dark room in a state in which the ultraviolet radiation was blocked, it remained yellow; and when the thin film, having turned yellow, was irradiated with visible rays having a wavelength of 532 nm and 5 m, it became colorless again, and the fluorescence intensity of the thin film was consequently decreased.

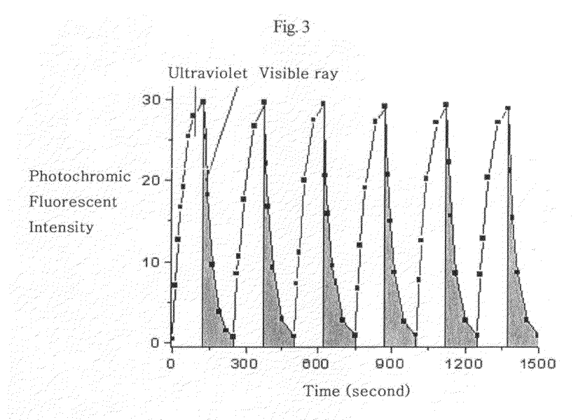

Here, when the thin film was repeatedly irradiated with ultraviolet and visible rays, a phase separation phenomenon did not occur, and a photochromic phenomenon and a fluorescence switching phenomenon occurred. These phenomena are shown in FIG. 3. Here, FIG. 3 shows the fluorescence switching characteristics of the thin film with respect to ultraviolet having radiation a wavelength of 365 nm and visible rays having a wavelength of 532 nm.

### Example 26

Manufacture of Photochromic Fluorescent Thin Film

1 g of the polymer prepared in Example 23 and 9 g of polymethylmethacrylate, serving as a support, were dissolved in 30 mL of a cosolvent of chloroform and tetrachloroethane to form a mixed solution, and then the mixed solution was applied on a quartz glass plate using a spin coating machine.

Subsequently, the quartz glass plate coated with the solution was dried in a vacuum oven [OV-11, JEIO TECH CORP., Korea] at a temperature of 80° C. for 4 hours, thereby manufacturing a transparent thin film having a thickness of 5 μm.

As a result, when the manufactured thin film was irradiated with ultraviolet radiation (PowerArc UV100), it fluoresced strongly and simultaneously turned yellow; when it was left in a dark room in a state in which the ultraviolet radiation was blocked, it remained yellow, and when the thin film, having turned yellow, was irradiated with visible rays having a wavelength of 532 nm using a laser (Cobolt Samba™ 532 nm DPSSL, single-longitudinal mode (SLM) 25 mW CW), it became colorless again, and the fluorescence intensity of the thin film was consequently decreased.

Further, when the thin film was repeatedly irradiated with ultraviolet and visible rays, a phase separation phenomenon did not occur, and a photochromic phenomenon and a fluorescence switching phenomenon occurred.

### INDUSTRIAL APPLICABILITY

According to the present invention, the present invention is effective in that it provides a photoactive aromatic polymer having high conductivity and fluorescence, including an aromatic compound as a backbone, through the polymerization of aromatic polycyclic monomers.

Further, the present invention is effective in that it provides a photoactive aromatic polymer having high conductivity and fluorescence, even in a state in which the photoactive aromatic polymer is formed into a thin film.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

I claim:

1. A photoactive aromatic polymer, represented by Formula 1 below, including an aromatic compound as a backbone: 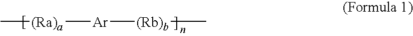
wherein, n is an integer equal to or greater than 2; each of a and b is an integer from 0 to 20 but a and b are not both 0; Ar is a substituted or unsubstituted polycyclic aromatic ring; and each of Ra and Rb is selected from the group consisting of an alkylene, alkyleneoxyalkylene, alkylenethioalkylene, and cyclic alkylene of 1 to 20 carbon atoms.

2. The photoactive aromatic polymer according to claim 1, wherein the Ar, which is the substituted or unsubstituted polycyclic aromatic ring, is a ring selected from the group consisting of anthracene, biphenyl ether, biphenyl alkylene, biphenyl sulfide, naphthalene, pyrene, perylene, pentacene, thiophene and derivatives thereof, biphenyl, thienylenevinylene, oligothiophene, and oligobiphenyl.

3. A thin film comprising the photoactive aromatic polymer according to claim 1.

4. A recording medium film comprising the photoactive aromatic polymer according to claim 1.

5. A display comprising the photoactive aromatic polymer according to claim 1.

6. A thin film composition, comprising:
0.1 to 90% by weight of the photoactive aromatic polymer according to claim 1;
10 to 99.9% by weight of one or more compounds selected from the group consisting of polyolefin, polycarbonate, polymethylmethacrylate, polyester, polyvinyl alcohol, polyimide, epoxy, polyurethane, a styrene-diene polymer, and a mixture thereof, and
0 to 90% by weight of an organic solvent.

7. A method of preparing a photoactive aromatic polymer, comprising the steps of:
preparing a mixture by mixing 1 to 80% by weight of an aromatic polycyclic compound monomer represented by Formula 2 below, 15 to 98.05% by weight of X—CH₂OCH₃ (where, X is selected from the group consisting of F, Cl, Br, and I), and 0.05 to 70% by weight of an acid catalyst, based on a total weight of the mixture; and
polymerizing the mixture at a temperature of −78˜150° C.:
Y—(Ra)ₐ—Ar—(Rb)_{b}-Z (Formula 2),
wherein each of a and b is an integer from 0 to 20; Ar is a substituted or unsubstituted polycyclic aromatic ring; each of Ra and Rb is selected from the group consisting of an alkylene, alkyleneoxyalkylene, alkylenethioalkylene, and cyclic alkylene of 1 to 20 carbon atoms; and each of Y and Z is selected from the group consisting of H, Cl, F, Br, and I.

8. The method of preparing a photoactive aromatic polymer according to claim 7, wherein the Ar, which is the substituted or unsubstituted polycyclic aromatic ring, is a ring selected from the group consisting of anthracene, biphenyl ether, biphenyl alkylene, biphenyl sulfide, naphthalene, pyrene, perylene, pentacene, thiophene and derivatives thereof, biphenyl, thienylenevinylene, oligothiophene, and oligobiphenyl.

9. The method of preparing a photoactive aromatic polymer according to claim 7, wherein the acid catalyst is one or more mixtures selected from the group consisting of TiCl₄, SnCl₄, FeCl₃, AlCl₃, SbCl₅, POCl₃, TeCl₂, BiCl₃, ZnCl₂, ReCl₁₆, TiBr₄, BF₃Et₂O, Sc(OTf)₃, TiF₄, CF₃SO₃H, H₂SO₄, and mixtures thereof.

10. The method of preparing a photoactive aromatic polymer according to claim 7, further comprising the step of:
adding 1 to 99% by weight of a compound represented by Formula 3 below, based on a total weight of the mixture, to the mixture: 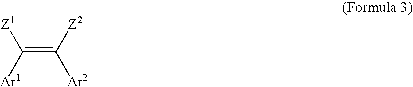
wherein each of Z¹ and Z² is selected from the group consisting of a cyano group, maleic anhydride, maleimide dihydrothiophene, thiophene, and a ring of 4 to 6 atoms unsubstituted or substituted with fluorine by the combination of Z¹ and Z² with each other; each of Ar¹ and Ar² is selected from the group consisting of 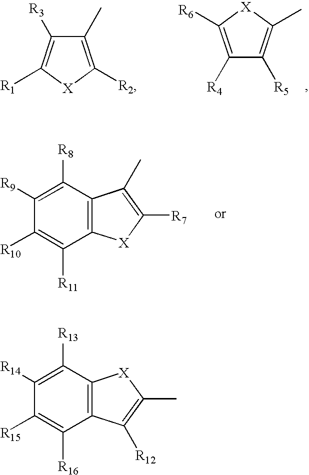
(where, each of X and Y is selected from the group consisting of O, S, NH, N—CH₃, sulfone(SO₂) and sulfoxide(SO)); each of R₂, R₅, R₇ and R₁₂ is selected from the group consisting of a substituted or unsubstituted alkyl group of C₁ to C₇, a substituted or unsubstituted alkyloxy group, a substituted or unsubstituted benzene ring, a substituted or unsubstituted thiophene, and a substituted or unsubstituted vinyl group; each of R₃ and R₆ is selected from the group consisting of a hydrogen atom, a fluorine atom, and a substituted or unsubstituted alkyl group of C₁ to C₃; each of R₁, R₄, R₈ to R₁₁, and R₁₃ to R₁₆ is selected from the group consisting of —H, a halogen atom, a substituted or unsubstituted alkyl group of C₁ to C₇, a substituted or unsubstituted alkyloxy group, substituted or unsubstituted thiophene, a substituted or unsubstituted vinyl group, a substituted or unsubstituted triple bond, a substituted or unsubstituted benzene ring, —C(═O)CH₃, an isoxazol group, —C(═O)—CH₂—Ar³, —C(═O)—Ar⁴, and —N(Ar⁵)₂; each of Ar³, Ar⁴ and Ar⁵ is selected from the group consisting of a substituted or unsubstituted benzene ring and thiophene; and at least one of R₁, R₃, R₄, R₆, R₈ to R₁₁ and R₁₃ to R₁₆ is at least one selected from the group consisting of hydrogen and alkyl halide.
